(19) United States
(12) Patent Application Publication
(10) Pub. No.: US 2026/0143385 A1
(43) Pub. Date: May 21, 2026

(54) PROBABILISTIC AMPLITUDE SHAPING FOR COMMUNICATIONS SYSTEMS

(71) Applicant: Lenovo (United States) Inc., Morrisville, NC (US)

(72) Inventors: Junghoon Kim, Chicago, IL (US); Venkata Srinivas Kothapalli, Chicago, IL (US)

(21) Appl. No.: 19/451,949

(22) Filed: Jan. 16, 2026

(51) Int. Cl. H04W 28/22; H04B 7/06; H04B 17/309

(52) U.S. Cl. CPC H04W 28/22; H04B 7/0632; H04B 17/346

(57) ABSTRACT

Various aspects of the present disclosure relate to probabilistic shaping for communications systems. A base station can obtain a value of a channel condition parameter and a number of symbols (n). The base station can identify the system tuple of the plurality of system tuples that corresponds to the value of the obtained channel condition parameter based on a data structure. The data structure can comprise a plurality of channel condition parameters associated with a plurality of system tuples in which each system tuple comprises a discrete modulation order (m), a shaping parameter (v), and a fraction factor (γ). The base station can transmit, to user equipment, first information associated with the system tuple that corresponds to the value of the obtained channel condition parameter and second information associated with the obtained number of symbols.

### TECHNICAL FIELD

The present disclosure relates to communications, and more specifically to probabilistic shaping for wireless communications systems.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

The devices (e.g., NE, UE), processors, and methods of the present disclosure each have several innovative aspects, no single one of which is solely responsible for the desirable features disclosed herein.

A NE (e.g., a base station) for wireless communication is described. The base station may be configured to, capable of, or operable to perform one or more operations as described herein. For example, the NE may be configured to, capable of, or operable to obtain a value of a channel condition parameter and a number of symbols (n). The NE can identify the system tuple of the plurality of system tuples that corresponds to the obtained value of the channel condition parameter based at least in part on a data structure. The data structure can comprise a plurality of channel condition parameters associated with a plurality of system tuples. Each system tuple of the plurality of system tuples can comprise a discrete modulation order (m), a shaping parameter (v), and a fraction factor (γ). Each system tuple can correspond to a different value of the channel condition parameter of the plurality of channel condition parameters. The NE can transmit, to a user equipment (UE), first information associated with the system tuple that corresponds to the obtained value of the channel condition parameter and/or second information associated with the obtained number of symbols.

In some instances, the channel condition parameter can comprise a signal to noise ratio (SNR), a signal to interference plus noise ratio (SINR), or a channel quality indicator (CQI).

In some instances, determining the shaping parameter (v) for each system tuple of the plurality of system tuples can comprise a bisection search that identifies a value in which a block error rate (BLER) associated with the channel condition parameter matches a BLER constraint that is based at least in part on the fraction factor (γ).

In some instances, the system tuple can be identified based at least in part on performance of a one-dimensional search over the fraction factor (γ) to identify a pair of (v, γ) that maximizes a data rate. The shaping parameter (v) can be dependent on the fraction factor (γ).

In some instances, based at least in part on a type of the channel condition parameter, the data structure can map a continuous range of channel condition parameter values to a discrete index associated with the system tuple.

In some instances, the NE can further comprise a distribution matcher (DM) that is configured to cause the determination (e.g., determination by a base station) of amplitude symbols following a probability distribution based at least in part on the shaping parameter (v). The DM can comprise a hardware DM or a software DM.

In some instances, the one or more processors can cause the NE to determine a data rate associated with the system tuple. The data rate can be approximated with an entropy of amplitude symbols and the fraction factor (γ).

In some instances, the data structure can comprise a look-up table, a sorted array, or a coefficient array.

In some instances, the one or more processors can cause the NE to transmit information associated with an updated system tuple that is based at least in part on real-time variations in the channel condition parameter.

In some instances, the one or more processors can cause the NE to, based at least in part on the channel condition parameter being continuous, quantize the channel condition parameter to a nearest discrete value or index defined in the data structure.

In some instances, the one or more processors can cause the NE to determine, based at least in part on the fraction factor (γ), a number of non-shaped information bits allocated to a Forward Error Correction (FEC) encoder relative to a total number of transmit symbols.

A processor (e.g., a standalone processor chipset, or a component of a UE) for wireless communication is described. The processor may be configured to, capable of, or operable to perform one or more operations as described herein. For example, the processor may be configured to, capable of, or operable to obtain a value of a channel condition parameter and a number of symbols (n). The processor can identify the system tuple of the plurality of system tuples that corresponds to the obtained value of the channel condition parameter based at least in part on a data structure. The data structure can comprise a plurality of channel condition parameters associated with a plurality of system tuples. Each system tuple of the plurality of system tuples can comprise a discrete modulation order (m), a shaping parameter (v), and a fraction factor (γ). Each system tuple can correspond to a different value of the channel condition parameter of the plurality of channel condition parameters. The processor can transmit, to a user equipment (UE), first information associated with the system tuple that corresponds to the obtained value of the channel condition parameter and/or second information associated with the obtained number of symbols.

A method performed or performable by a UE for wireless communication is described. The method may include obtaining a value of a channel condition parameter and a number of symbols (n). The method may include identifying the system tuple of the plurality of system tuples that corresponds to the obtained value of the channel condition parameter based at least in part on a data structure. The data structure can comprise a plurality of channel condition parameters associated with a plurality of system tuples. Each system tuple of the plurality of system tuples can comprise a discrete modulation order (m), a shaping parameter (v), and a fraction factor (γ). Each system tuple can correspond to a different value of the channel condition parameter of the plurality of channel condition parameters. The method may include transmitting, to a user equipment (UE), first information associated with the system tuple that corresponds to the obtained value of the channel condition parameter and/or second information associated with the obtained number of symbols.

A NE (e.g., a base station) for wireless communication is described. The base station may be configured to, capable of, or operable to perform one or more operations as described herein. For example, the NE may be configured to, capable of, or operable to obtain a channel condition parameter and a number of symbols (n). The NE can select a discrete modulation order (m) from a plurality of candidate values. The NE can determine, using a data rate optimization function based at least in part on the channel condition parameter, a system tuple comprising the discrete modulation order (m), a shaping parameter (v), and a fraction factor (γ) for a probabilistic amplitude shaping (PAS) scheme by reducing a solution space for the shaping parameter (v) and the fraction factor (γ) based at least in part on a channel capacity threshold. Furthermore, the NE can generate a data structure that associates the system tuple with the channel condition parameter.

A processor (e.g., a standalone processor chipset, or a component of a UE) for wireless communication is described. The processor may be configured to, capable of, or operable to perform one or more operations as described herein. For example, the processor may be configured to, capable of, or operable to obtain a channel condition parameter and a number of symbols (n). The processor can select a discrete modulation order (m) from a plurality of candidate values. The processor can determine, using a data rate optimization function based at least in part on the channel condition parameter, a system tuple comprising the discrete modulation order (m), a shaping parameter (v), and a fraction factor (γ) for a PAS scheme by reducing a solution space for the shaping parameter (v) and the fraction factor (γ) based at least in part on a channel capacity threshold. Furthermore, the processor can generate a data structure that associates the system tuple with the channel condition parameter.

A method performed or performable by a NE for wireless communication is described. The method may include obtaining a channel condition parameter and a number of symbols (n). The method can include selecting a discrete modulation order (m) from a plurality of candidate values. The method can include determining, using a data rate optimization function based at least in part on the channel condition parameter, a system tuple comprising the discrete modulation order (m), a shaping parameter (v), and a fraction factor (γ) for a PAS scheme by reducing a solution space for the shaping parameter (v) and the fraction factor (γ) based at least in part on a channel capacity threshold. Furthermore, the method can include generating a data structure that associates the system tuple with the channel condition parameter.

In some instances, the method can include identifying an achievable data rate that is associated with the channel condition parameter and corresponds to a block error rate (BLER) constraint.

In some instances, the method can include reducing, based at least in part on application of a channel capacity constraint to a parameter pair, the solution space for the parameter pair, wherein the parameter pair comprises the shaping parameter and the fraction factor.

In some instances, the method can include determining, for each candidate fraction factor of a plurality of candidate fraction factors, based at least in part on application of a bisection search to a range of values for the shaping parameter, the shaping parameter that matches the BLER constraint.

In some instances, the method can include identifying the parameter pair for the discrete modulation order that results in the achievable data rate by performing a search over the plurality of candidate fraction factors.

In some instances, the method can include determining, based at least in part on the selected discrete modulation, the reduced solution space, the shaping parameter that matches the BLER constraint, the identified parameter pair, the system tuple comprising the discrete modulation order, the shaping parameter, and the fraction factor that results in the achievable data rate.

A UE for wireless communication is described. The UE may be configured to, capable of, or operable to perform one or more operations as described herein. For example, the UE may be configured to, capable of, or operable to obtain information associated with a received system tuple and/or a number of symbols (n) that are associated with received data. Further, the UE can identify, based at least in part on a data structure and/or the information associated with the received system tuple, an identified system tuple of the plurality of system tuples, that corresponds to the received data. The data structure can comprise a plurality of channel condition parameters associated with a plurality of system tuples. Each system tuple of the plurality of system tuples can comprise a discrete modulation order (m), a shaping parameter (v), and a fraction factor (γ). Each system tuple can correspond to a different value of the channel condition parameter of the plurality of channel condition parameters. Furthermore, the UE can decode, based at least in part on the identified system tuple and/or the obtained number of symbols (n), the received data.

In some instances, the information associated with the data structure is transmitted to the UE from a base station.

In some instances, the identified system tuple is used to decode the received data a predefined time period after the received data was received.

A processor (e.g., a standalone processor chipset, or a component of a UE) for wireless communication is described. The processor may be configured to, capable of, or operable to perform one or more operations as described herein. For example, the processor may be configured to, capable of, or operable to obtain information associated with a received system tuple and/or a number of symbols (n) that are associated with received data. Further, the processor can identify, based at least in part on a data structure and/or the information associated with the received system tuple, an identified system tuple of the plurality of system tuples, that corresponds to the received data. The data structure can comprise a plurality of channel condition parameters associated with a plurality of system tuples. Each system tuple of the plurality of system tuples can comprise a discrete modulation order (m), a shaping parameter (v), and a fraction factor (γ). Each system tuple can correspond to a different value of the channel condition parameter of the plurality of channel condition parameters. Furthermore, the processor can decode, based at least in part on the identified system tuple and/or the obtained number of symbols (n), the received data.

A method performed or performable by a UE for wireless communication is described. The method may include obtaining information associated with a received system tuple and a number of symbols (n) that are associated with received data. Further, the method can include identifying, based at least in part on a data structure and/or the information associated with the received system tuple, an identified system tuple of the plurality of system tuples, that corresponds to the received data. The data structure can comprise a plurality of channel condition parameters associated with a plurality of system tuples. Each system tuple of the plurality of system tuples can comprise a discrete modulation order (m), a shaping parameter (v), and a fraction factor (γ). Each system tuple can correspond to a different value of the channel condition parameter of the plurality of channel condition parameters. Furthermore, the method can include decoding, based at least in part on the identified system tuple and/or the obtained number of symbols (n), the received data.

### BRIEF DESCRIPTION OF THE DRAWINGS

FIG. 1 illustrates an example of a wireless communications system in accordance with aspects of the present disclosure.

FIG. 2 illustrates a communication flow diagram for probabilistic shaping in accordance with aspects of the present disclosure.

FIG. 3 illustrates a communication flow diagram for probabilistic shaping in accordance with aspects of the present disclosure.

FIG. 4 illustrates a communication flow diagram for probabilistic shaping in accordance with aspects of the present disclosure.

FIG. 5 illustrates an example of a probabilistic amplitude shaping framework in accordance with aspects of the present disclosure.

FIG. 6 illustrates an example of a two-dimensional solution space in accordance with aspects of the present disclosure.

FIG. 7 illustrates an example of a UE in accordance with aspects of the present disclosure.

FIG. 8 illustrates an example of a processor in accordance with aspects of the present disclosure.

FIG. 9 illustrates an example of an NE in accordance with aspects of the present disclosure.

FIG. 10 illustrates a flowchart of a method performed by a NE in accordance with aspects of the present disclosure.

FIG. 11 illustrates a flowchart of a method performed by a NE in accordance with aspects of the present disclosure.

FIG. 12 illustrates a flowchart of a method performed by a UE in accordance with aspects of the present disclosure.

### DETAILED DESCRIPTION

The present disclosure relates to communication systems and more particularly to probabilistic shaping for wireless communication systems. The disclosed technology is directed to improving the effectiveness with which PAS parameters are implemented in wireless communication systems (e.g., 5G and/or 6G networks). The disclosed technology is directed to increasing data transmission rates and improving the reliability of transmitted signals by more effectively determining system tuples (e.g., a discrete modulation order (m), a continuous shaping parameter (v), and a fraction factor (γ)) for use in wireless communications. To overcome the computational complexity associated with selecting these parameters, the disclosed technology can use a multi-step strategy. First, the disclosed technology can reduce the solution space by applying a channel capacity constraint to discard parameter combinations in which the data rate theoretically exceeds channel capacity. Second, the disclosed technology can reduce the search dimensionality from two dimensions to one by using a bisection search to find the specific shaping parameter (v) that meets a BLER constraint for a given fraction factor (γ). Consequently, the system may perform a less computationally expensive one-dimensional search over the fraction factor (γ). The resulting optimal tuples can be stored in a data structure (e.g., a mapping data structure), such as a look-up table, enabling NE to efficiently select parameters based at least in part on real-time channel conditions like SNR.

The disclosed technology addresses the computational complexity associated with optimizing transmission parameters for PAS in wireless systems. PAS can increase data rates by configuring the symbol probabilities to mimic a Gaussian distribution, thereby narrowing the gap to a channel capacity limit and improving both data rate and error performance. Specifically, the probability of a symbol can be modeled using a Maxwell-Boltzmann distribution, in which the shaping parameter (v) controls the concentration of the distribution. However, introducing PAS adds an extra degree of freedom to the system configuration: the shaping parameter itself. This additional variable means that the wireless system optimizes three key variables instead of just two. These variables are the discrete modulation order (m), the fraction factor (γ), and the shaping parameter (v). The fraction factor can be used in determining the number of non-shaped information bits allocated to the FEC encoder, while the modulation order can take discrete values like 2, 4, 6, 8, or 10.

One approach to finding the optimal tuple (m, v, γ) comprises an exhaustive search over these parameters to satisfy both a Block Error Rate (BLER) constraint and a required data rate. Because the modulation order is discrete, the bulk of the complexity lies in configuring the two continuous variables, the fraction factor γ and the shaping parameter v. Since these variables exist in the continuous domain, there are infinitely many combinations that could potentially satisfy the data rate constraint. Even if the system selects a candidate tuple that achieves the desired rate, the system may then calculate the BLER through the transmit-receive chain to check if the tuple meets the BLER constraint.

This exhaustive search process can utilize significant time and processing resources to identify an optimal or near-optimal solution, making it computationally prohibitive for practical implementation. The complexity is further compounded because the data rate and BLER are dependent on the intricate interplay between v and γ, and the data rate may be approximated as the entropy of amplitude symbols plus the fraction factor. Consequently, finding the optimal solution for a PAS system can become challenging, preventing the efficient deployment of advanced signaling techniques in next-generation base stations. The disclosed technology aims to solve this dimensionality issue through the addition of a shaping parameter that transforms an unmanageable optimization problem into one that is computationally feasible.

The disclosed technology provides a solution by introducing a structured, efficient method to find the optimal system tuple (m, v, γ) without resorting to a full exhaustive search. The solution rests on reducing the geometric solution space and reducing the dimensionality of the search itself. Initially, the method assumes that the channel condition, such as SNR, and the number of symbols are given. The optimization focuses on configuring the two continuous variables, v and γ, for a given discrete modulation order m.

The first part of the solution applies a theoretical bound to limit the search area based at least in part on a channel capacity constraint. This channel capacity constraint indicates that for reliable communications, the achievable data rate may not exceed the channel capacity. In additive white Gaussian noise (AWGN) channels, this capacity may be defined logarithmically based at least in part on the SNR. Any combination of the shaping parameter and fraction factor that results in a data rate higher than the channel capacity will inherently fail to meet the BLER constraint. Therefore, the disclosed technology discards the regions in which the rate exceeds capacity, effectively reducing the solution space compared to the entire region of valid γ and v values.

The second part of the solution can reduce the complexity of searching the remaining space from a two-dimensional search to a one-dimensional search. Instead of searching a 2D grid of v and γ, the disclosed technology exploits specific monotonic properties of the system. The Block Error Rate (BLER) can represent a non-increasing function of the shaping parameter v because as v increases, the symbol distribution concentrates and spacing increases, reducing errors. Further, the data rate can be a non-increasing function of v because as the distribution moves away from uniform, the entropy of the amplitude symbols decreases.

Leveraging these properties, the system can determine that for a fixed γ, the data rate is maximized when the BLER constraint is met with equality. Consequently, the system does not need to search blindly for the best v. Instead, it calculates the specific v that satisfies the BLER constraint for any given γ. The solution implements a bisection search, a fast numerical method, to identify this optimal v* for each candidate γ. This allows the optimization problem to be reformulated as a one-dimensional search over γ to identify the pair that maximizes the data rate.

Once the optimal tuples are identified for various channel conditions, the tuples can be stored in a data structure, such as a look-up table (LUT), sorted array, or coefficient array. During operation, the base station obtains a channel condition parameter, such as SNR or CQI, and accesses this pre-calculated data structure to retrieve the optimal tuple. The base station can then transmit information associated with this tuple to the User Equipment (UE) to enable decoding. The UE can use this information to identify the system tuple corresponding to the received data and decodes it accordingly. This approach can simplify the complex joint optimization into a manageable process that can be pre-calculated and rapidly accessed.

The benefits of the disclosed technology described in the attached documents comprise improvements in efficiency, performance optimization, and practical feasibility for next-generation wireless systems. By solving the computational bottlenecks of PAS, the disclosed technology enables the practical deployment of this advanced signaling technique. One of the benefits is the drastic reduction in the computational resources required to configure the system parameters. By applying a channel capacity constraint, the system avoids wasting processing power on parameter combinations that are theoretically improbable to implement reliably. By pruning the search space, the optimizer focuses on viable candidates, effectively streamlining the process.

Furthermore, the shift from a two-dimensional search to a one-dimensional search represents a fundamental algorithmic improvement. In a traditional exhaustive approach, the system would need to test a vast grid of values for the shaping parameter v and the fraction factor γ. With the proposed solution, the system can iterate through γ and use a fast bisection method to find v. This transforms the problem from a computationally expensive grid search into a streamlined linear process, effectively resolving the dimensionality issues that can hinder PAS optimization. This reduction in complexity enables the configuration of high-performance wireless systems without requiring prohibitive amounts of computational power.

Another benefit of the disclosed technology is the maximization of data rates, or spectral efficiency. The disclosed technology is configured to operate as close to the theoretical channel capacity as possible. By efficiently finding the precise tuple (m, v, γ) that maximizes the data rate while meeting the reliability constraint (e.g., the BLER constraint), the system squeezes the maximum possible information throughput out of the available bandwidth. By enabling the practical use of PAS, the disclosed technology can allow the system to recover that loss, providing higher spectral efficiency that may meet the performance targets of 6G networks.

The disclosed technology also enhances reliability and granularity in system performance. The use of the bisection search to find the shaping parameter v that satisfies the BLER constraint with equality means that the system does not over-emphasize reliability at the expense of data rate. The disclosed technology can determine the point at which the connection is as reliable as required, allowing the remaining signal margin to be used for transmitting more data. This precise tuning allows for a highly optimized balance between robustness and speed. Additionally, the generation of a robust LUT means the base station can adapt rapidly to changing channel conditions such as SNR, SINR, and CQI.

The system can be configured to generate a data structure that covers a continuous range of channel parameters, sometimes quantizing them to discrete indices for fast retrieval. This means that as users move or interference patterns change, the link adaptation is both optimal and instantaneous. The reduced complexity makes it feasible to implement these optimization routines or the resulting look-up tables in actual base station hardware, which often has strict latency and processing limits. Furthermore, the disclosed technology describes a clear signaling mechanism where the base station conveys the information to the User Equipment (UE). This clarity supports interoperability, where UEs can successfully decode the PAS signals by accessing the corresponding data structures.

Aspects of the present disclosure are described in the context of a wireless communications system. Additional details of one or more implementations of the present disclosure are set forth in the accompanying drawings and the description below. Other aspects and advantages will become apparent from the description, the drawings, and the claims.

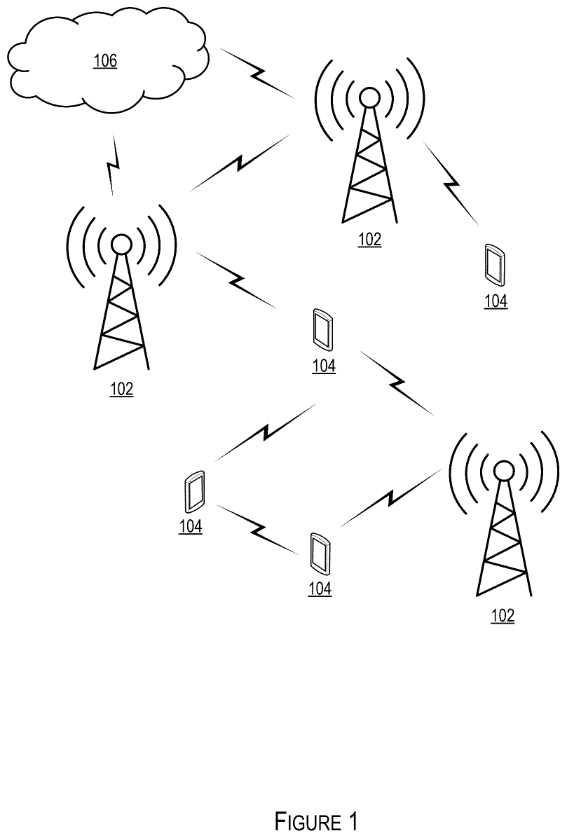

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

In some implementations, an NE 102 may be implemented in a disaggregated architecture (e.g., a disaggregated base station architecture, a disaggregated RAN architecture), which may be configured to utilize a protocol stack that may be physically or logically distributed among multiple network entities (e.g., NEs 102), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, an NE 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), or any combination thereof Δn RU may also be referred to as a radio head, a smart radio head, a remote radio head (RRH), a remote radio unit (RRU), or a transmission reception point (TRP). The split of functionality between a CU, a DU, and an RU may be flexible and may support different functionalities depending on which functions (e.g., network layer functions, protocol layer functions, baseband functions, RF functions, or any combinations thereof) are performed at a CU, a DU, or an RU.

One or more components of the NEs 102 in a disaggregated RAN architecture may be co-located, or one or more components of the NEs 102 may be located in distributed locations (e.g., separate physical locations). Additionally, or alternatively, in some examples, one or more of the NEs 102 of a disaggregated RAN architecture may be implemented as virtual units (e.g., a virtual CU (VCU), a virtual DU (VDU), a virtual RU (VRU)).

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

The wireless communications system 100 may be configured to support reliable communications or low-latency communications, or various combinations thereof. For example, the wireless communications system 100 may be configured to support ultra-reliable low-latency communications (URLLC). The UEs 104 may support reliable, low-latency, or critical functions. Ultra-reliable communications may include private communication or group communication. Support for reliable, low-latency functions may include prioritization of services, and such services may be used for public safety or general commercial applications. The terms ultra-reliable, low-latency, and ultra-reliable low-latency may be used interchangeably herein.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based at least in part on one or more numerologies.

One or more numerologies may be supported in the wireless communications system 100, and a numerology may include a subcarrier spacing and a CP. A first numerology (e.g., μ=0) may be associated with a first subcarrier spacing (e.g., 15 kHz) and a normal CP. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal constellation point (CP). A third numerology (e.g., μ=²) may be associated with a third subcarrier spacing (e.g., 60 kHz) and a normal CP or an extended CP. A fourth numerology (e.g., μ=³) may be associated with a fourth subcarrier spacing (e.g., 120 kHz) and a normal CP. A fifth numerology (e.g., μ=⁴) may be associated with a fifth subcarrier spacing (e.g., 240 kHz) and a normal CP.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols. In some implementations, the number (e.g., quantity) of slots for a subframe may depend on a numerology. For a normal CP, a slot may include 15 symbols. For an extended CP (e.g., applicable for 60 kHz subcarrier spacing), a slot may include 12 symbols. The relationship between the number of symbols per slot, the number of slots per subframe, and the number of slots per frame for a normal CP and an extended CP may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based at least in part on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In some implementations, the NEs can comprise a base station that is configured to obtain a value of a channel condition parameter and a number of symbols (n). The NE can access a data structure comprising a plurality of channel condition parameters associated with a plurality of system tuples. The NE can identify the system tuple of the plurality of system tuples that corresponds to the obtained value of the channel condition parameter. Furthermore, the NE can transmit, to a user equipment (UE), information associated with the system tuple that corresponds to the obtained value of the channel condition parameter.

Furthermore, in some instances, the NE can be configured to obtain a channel condition parameter and a number of symbols (n). The NE can select a discrete modulation order (m) from a plurality of candidate values. The NE can determine, using a data rate optimization function based at least in part on the channel condition parameter, a system tuple comprising the discrete modulation order (m), a shaping parameter (v), and a fraction factor (γ) for a PAS scheme by reducing a solution space for the shaping parameter (v) and the fraction factor (γ) based at least in part on a channel capacity threshold. Furthermore, the NE can generate a data structure that associates the system tuple with the channel condition parameter.

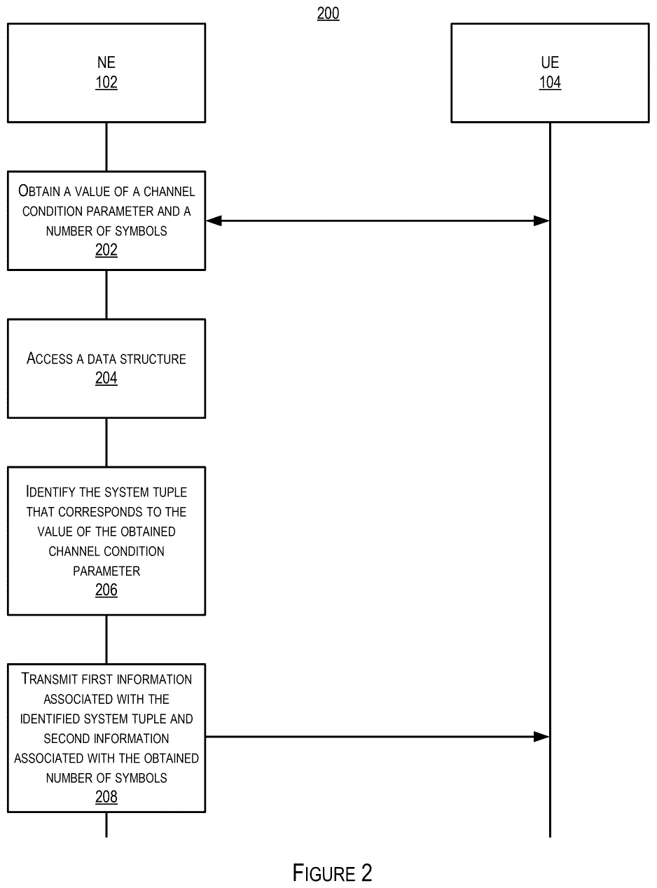

FIG. 2 illustrates a communication flow diagram for probabilistic shaping in accordance with aspects of the present disclosure. The operations described with respect to the communications system 200 may be implemented by one or more NEs and/or one or more UEs as described herein.

At 202, the NE 102 can obtain a value of a channel condition parameter and a number of symbols (n). For example, the NE can measure or receive information associated with the quality of the communication link. The channel condition parameter can comprise a SNR, a Signal-to-Interference-Plus-Noise Ratio (SINR), or a Channel Quality Indicator (CQI). In some instances, the NE can obtain these values in real-time, the system prepares to select a system tuple that maximizes spectral efficiency without violating error rate constraints.

At 204, the NE 102 can access a data structure that can comprise a plurality of channel condition parameters associated with a plurality of system tuples. The data structure can comprise a repository of pre-optimized solutions, allowing the NE to bypass complex calculations during active transmission.

At 206, the NE 102 can identify the system tuple of the plurality of system tuples that corresponds to the obtained value of the channel condition parameter. If the channel condition parameter obtained (e.g., SNR) is a continuous value that does not perfectly match an entry in the table, the NE may quantize the parameter to the nearest discrete value or index defined in the mapping structure.

At 208, the NE 102 can transmit, to a user equipment (UE), first information associated with the system tuple that corresponds to the obtained value of the channel condition parameter and/or second information associated with the obtained number of symbols. By transmitting the tuple information (or an index pointing to it), the transmitter and receiver can be synchronized to the optimal probabilistic amplitude shaping configuration, thereby achieving data rates close to the theoretical channel capacity.

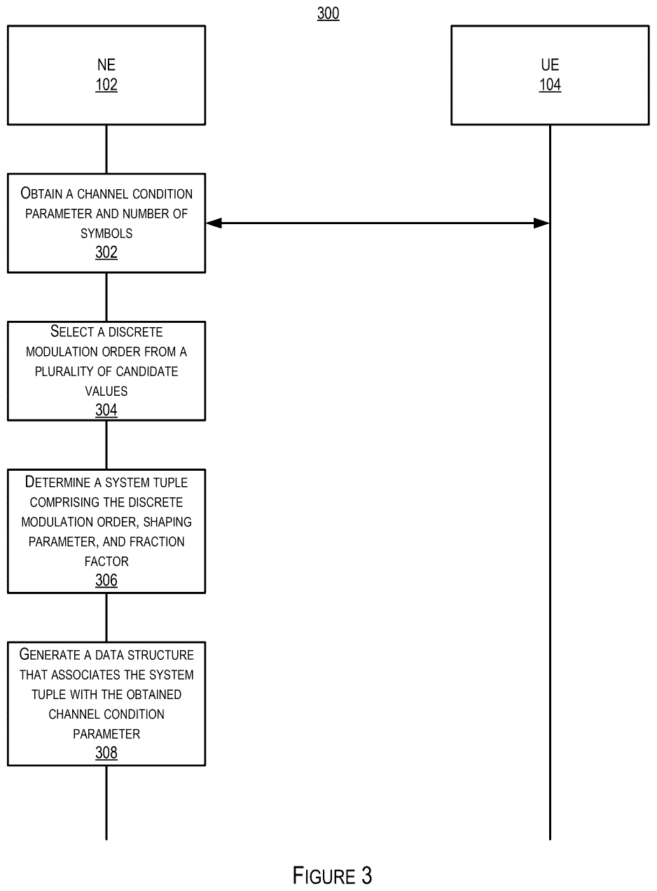

FIG. 3 illustrates a communication flow diagram for probabilistic shaping in accordance with aspects of the present disclosure. The operations described with respect to the communications system 300 may be implemented by one or more NEs and/or one or more UEs as described herein.

At 302, the NE 102 can obtain a channel condition parameter and/or a number of symbols (n). For example, the NE 102 can initialize the process by obtaining the foundational constraints: the channel condition parameter (e.g., Signal-to-Noise Ratio or SNR) and the obtained number of symbols (n).

At 304, the NE 102 can select a discrete modulation order (m) from a plurality of candidate values. For example, the NE 102 can select a discrete modulation order (m) from a set of candidate values (e.g., 2, 4, 6, 8, 10).

At 306, the NE 102 can determine a system tuple. Determining the system tuple can be based at least in part on using a data rate optimization function based at least in part on the channel condition parameter. The system tuple that can comprise the discrete modulation order (m), a shaping parameter (v), and a fraction factor (γ) for a PAS scheme by reducing a solution space for the shaping parameter (v) and the fraction factor (γ) based at least in part on a channel capacity threshold. For example, the NE 102 can perform operations to reduce the search space based at least in part on the channel capacity and reduce the dimensionality via implementation of a bisection search.

At 308, the NE 102 can generate a data structure that associates the system tuple with the channel condition parameter. For example, the NE 102 can generate an LUT based at least in part on the system tuple and channel condition parameter.

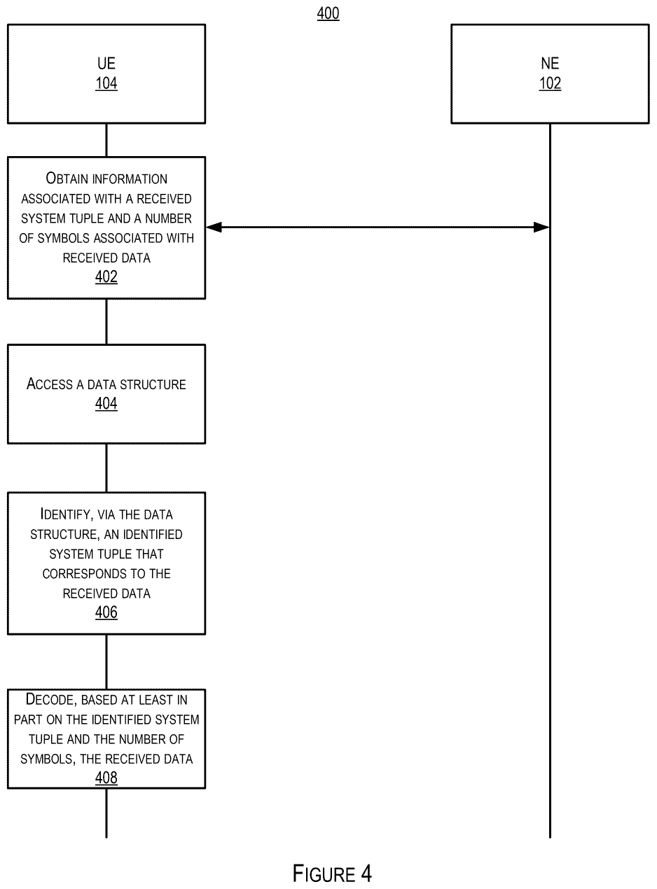

FIG. 4 illustrates a communication flow diagram for probabilistic shaping in accordance with aspects of the present disclosure. The operations described with respect to the communications system 400 may be implemented by one or more NEs and/or one or more UEs as described herein.

At 402, the UE 104 can obtain information associated with a received system tuple and/or a number of symbols (n) that can be associated with received data. For example, the UE 104 can comprise a receiving entity in a wireless communication system, such as a 5G or 6G network, and may interact with a NE device, such as a base station. The information obtained by the UE 104 can be used to synchronize the transmission parameters between the transmitter and the receiver. This information may be transmitted directly from the base station to the UE 104, providing the signaling to interpret the incoming waveform. The reception of this data can be handled by the UE 104's transceiver and receiver chains, which can process the signals from the wireless medium.

At 404, the UE 104 can access a data structure. The data structure can comprise a plurality of channel condition parameters associated with a plurality of system tuples. Each system tuple of the plurality of system tuples can comprise a discrete modulation order (m), a shaping parameter (v), and a fraction factor (γ) that corresponds to a different value of the channel condition parameter of the plurality of channel condition parameters. For example, the UE 104 can access a data structure that is based at least in part on the optimization logic performed by the NE 102. The data structure can comprise a plurality of channel condition parameters (such as SNR or CQI) associated with a plurality of system tuples. These structures may be implemented as look-up tables (LUTs), sorted arrays, or coefficient arrays stored within a memory of the UE 104.

At 406, the UE 104 can identify an identified system tuple that corresponds to the received data. Identifying the system tuple may be via the data structure. Identifying the system tuple may be based at least in part on the information associated with the received system tuple, an identified system tuple of the plurality of system tuples, that corresponds to the received data. For example, the UE 104 can identify the system tuple based at least in part on the information associated with the obtained number of symbols (n) and the channel condition parameter obtained in the previous steps (e.g., steps 402 and 404).

At 408, the UE 104 can decode the received data. Decoding the received data may be based at least in part on the system tuple (m, v, γ) and/or the obtained number of symbols (n). For example, the UE 104 may perform operations comprising using a 2^{m-1}-ASK (amplitude shift keying) demapper to process received symbols and generate Log-Likelihood Ratios (LLRs) for the Forward Error Correction (FEC) decoder. Based at least in part on the fraction factor (γ), the UE can separate the output into non-shaped bits and shaped bits. The shaped bits can be re-mapped to amplitude symbols and processed by a distribution dematcher. The dematcher can apply the specific shaping parameter (v) from the tuple to reverse the probabilistic shaping, effectively retrieving the original data stream.

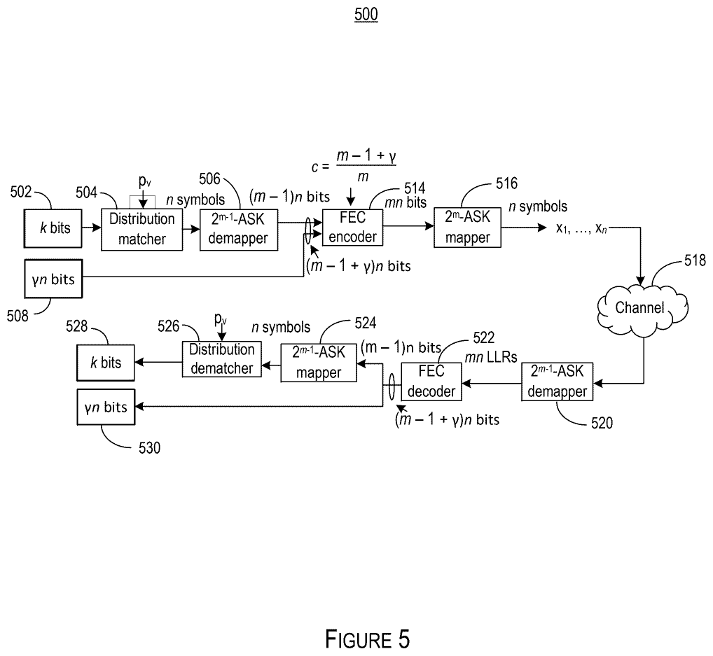

FIG. 5 illustrates an example of a probabilistic amplitude shaping framework in accordance with aspects of the present disclosure. The operations described with respect to the probabilistic framework 500 may be implemented by one or more NEs and/or one or more UEs as described herein.

FIG. 5 illustrates a schematic block diagram of a wireless communication system implementing a PAS framework. The system can be configured to transmit data over a communication channel (e.g., an AWGN channel), by processing symbol probabilities to approximate optimal signaling, thereby narrowing the gap to a channel capacity threshold.

The operation of the PAS framework as depicted in FIG. 5 can be based at least in part on a tuple of parameters (m, v, γ).

m (Modulation Order): A discrete value (e.g., 2, 4, 6, 8, 10) determining the constellation size.

v (Shaping Parameter): A continuous variable (v) controlling the peakedness of the symbol distribution.

γ (Fraction Factor): A continuous variable (γ<1) determining the ratio of unshaped bits.

The system can be configured to increase the data rate R {v,γ}while ensuring the BLER remains below a threshold ϵ. The data rate can be expressed as:

$$R ( v , γ ) = m \times {r}_{DM , v} \times c = m \times \frac{k + γ n}{( m - 1 + γ ) n} \times \frac{m - 1 + γ}{m} = \frac{k}{n} + γ \approx {H}_{v} ( {A}_{m} ) + γ .$$

Hᵥ(Aₘ) represents the entropy of the amplitudes.

This architecture can be configured to optimize the shaping parameter v, the fraction factor γ, and the modulation order m, rather than simply optimizing modulation and coding rate as in conventional uniform constellations. The disclosed technology can provide an efficient method for determining these parameters by reducing the solution space and utilizing a bisection search method based at least in part on the monotonic properties of BLER and data rate with respect to v.

The system can comprise a transmitter chain (e.g., operations 502-516), a channel (e.g., the channel in operation 518), and a receiver chain (e.g., operations 520-530). The processing can occur in the real domain, though it is understood that this can be extended to the complex domain by applying the framework separately to real and imaginary components.

The transmitter can be configured to process an input stream of information bits to generate a sequence of transmit symbols, denoted as n. The total input can comprise k+γ n information bits, which can be divided into two streams for processing. The first stream of k bits intended for shaping can be transmitted in operation 502. The second stream of γn bits which can comprise non-shaped information bits can be transmitted in operation 508.

In operation 504, the k information bits can be input into the DM, which can be configured to transform these uniformly distributed bits into a sequence of n amplitude symbols. A feature of this operation is that the output symbols follow a desired non-uniform distribution, specifically a Maxwell-Boltzmann (MB) distribution defined by probabilities Pᵥ={pᵥ(a)}_{a∈A}_{ₘ}.

The distribution can be based at least in part on a shaping parameter, denoted as v. The shaping parameter v can be associated with a probability pᵥ(a) of a symbol a the Maxwell-Boltzmann distribution, e.g., pᵥ(a)˜exp(−va²), to mimic the Gaussian distribution, in which v≥0 denotes the shaping parameter. The system can be configured such that as the shaping parameter v increases, the distribution of the amplitude symbols becomes more concentrated with lower variance. Conversely, as v decreases, the distribution approaches a uniform distribution. The set of amplitude symbols Aₘ={1, 3, . . . , 2^{m-1}}, in which the size of the set can be based at least in part on the modulation order m.

At operation 506, after processing by the distribution matcher, the n amplitude symbols can be passed to a block labeled 2^{m-1}-ASK demapper (e.g., an amplitude shift keying demapper). The demapper can be configured to de-map the amplitude symbols into a binary representation. The output of operation 506 can comprise (m−1)n bits, which can be referred to as the shaped (amplitude) bits. The (m−1)n bits can carry the statistical properties imposed by the distribution matcher but are now in a binary format suitable for Forward Error Correction (FEC) encoding.

At operation 514, an FEC Encoder configured to receive a combined payload of bits receives the (m−1)n shaped bits from the demapper. The FEC encoder concatenates or otherwise combines the (m−1)n bits with the second stream of input data, the γn non-shaped information bits. The parameter γ represents a fraction factor that determines the proportion of information bits allocated as unshaped bits. The FEC encoder processes this aggregate input of mn bits. The encoder can operate at a specific coding rate c, calculated as: c=(m−1+γ)/m.

The output of the FEC encoder can comprise a sequence of mn coded bits. Operation 514 can add redundancy to the signal to facilitate error correction at the receiver, while maintaining the statistical shaping imposed on the amplitude bits.

Operation 516, (e.g., the final stage of the transmitter chain) is performed by the 2^{m-1}-ASK mapper. The mn coded bits output by the FEC encoder are mapped to n transmit symbols in the real domain. Because the systematic bits (the shaped bits) were processed to follow the Maxwell-Boltzmann distribution, and the parity bits are assumed to be uniform, the resulting n transmit symbols effectively follow the desired MB distribution with the shaping parameter v.

In operation 518, the n transmit symbols can be transmitted across the channel. The transmitted symbols propagate through a channel. The channel can be modeled as an AWGN channel. The channel introduces noise which degrades the signal, necessitating the error correction and shaping schemes implemented by the transmitter and receiver.

Beginning at operation 520, the receiver can be configured to perform the reverse operations of the transmitter to retrieve the original k+γn information bits. At the operation 520, after receiving the noisy signal, the receiver uses a 2^{m-1}-ASK demapper to process the n received symbols. This unit calculates Log-Likelihood Ratios (LLRs) for the bits associated with the symbols, outputting mn LLRs. These LLRs are fed into the FEC decoder.

At operation 522, the FEC decoder can perform operations to correct errors introduced by the channel, outputting a corrected sequence of (m−1+γ)n bits. This sequence corresponds to the input of the FEC encoder at the transmitter. At this point, the data stream is split. At operation 530, the γn non-shaped information bits are extracted as one part of the recovered data.

At operation 524, the remaining (m−1)n bits, which correspond to the shaped bits, can be passed to a 2^{m-1}-ASK mapper. This mapper reconstructs the n amplitude symbols from the corrected bits. At operation 526, these n symbols are input into a distribution dematcher. The distribution dematcher can perform the inverse operation of the transmitter's distribution matcher, recovering the original k information bits which are provided at operation 528.

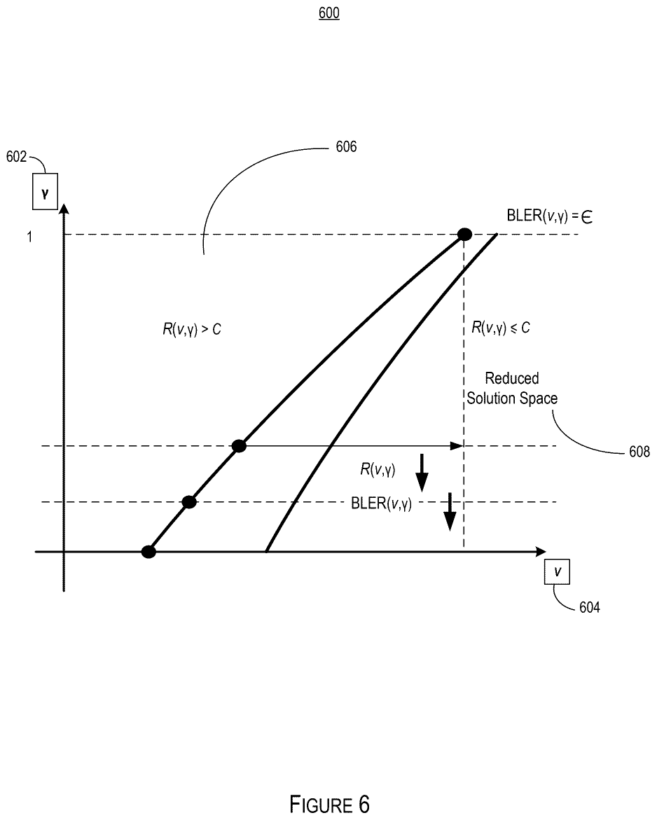

FIG. 6 illustrates an example of a two-dimensional (2D) solution space in accordance with aspects of the present disclosure. The 2D solution space 600 can be utilized for optimizing system parameters in a PAS communication system. FIG. 6 illustrates the relationship between the shaping parameter (v) and the fraction factor (γ) and the resulting system performance metrics, specifically the data rate (R) and the Block Error Rate (BLER).

The solution space is defined by a vertical axis 602 representing the fraction factor (γ) and a horizontal axis 604 representing the shaping parameter (v). The fraction factor 602 ranges from 0 to 1 and determines the proportion of information bits allocated as unshaped bits to the Forward Error Correction (FEC) encoder. The shaping parameter 604 (v>0) determines the peakedness of the Maxwell-Boltzmann distribution used for the amplitude symbols; a higher v indicates a more concentrated distribution, while a lower v approaches a uniform distribution.

The diagram visually partitions the solution space into two distinct regions based at least in part on theoretical channel capacity thresholds. The first region 606 represents a portion of the parameter space where the theoretically calculated data rate R(v, γ) would exceed the channel capacity (C) for a given channel condition (e.g., Signal-to-Noise Ratio). Reliable communication is not likely in region 606 because the transmission rate exceeds the physical limit of the channel (R(v, γ)>C). Consequently, any combination of v and γ falling within region 606 is discarded as a viable solution.

The second region 608 (shown with hatched lines) represents the reduced solution space where the data rate is less than or equal to the channel capacity (R(v, γ)≤C). The present disclosure leverages this distinction to significantly reduce computational complexity. By applying this capacity constraint as a filter, the system effectively prunes the search area, confining the optimization process strictly to the reduced solution space 608 where reliable communication is theoretically feasible. This prevents the processor from wasting resources evaluating parameter tuples that are physically improbable to implement reliably.

Within the reduced solution space 608, the behavior of the system can be based at least in part on monotonic properties illustrated by the directional arrows and curves. The solid curve running through the space represents the boundary where the Block Error Rate meets the target threshold (BLER(v, γ)=ϵ).

FIG. 6 illustrates BLER monotonicity and data rate monotonicity. With respect to BLER monotonicity, as the shaping parameter v increases (moving to the right along axis 604) for a fixed γ, the symbol distribution becomes more concentrated. This concentration increases the Euclidean distance between adjacent symbols in the constellation, thereby reducing the likelihood of symbol errors. Consequently, BLER(v, γ) can act as a non-increasing function of v.

With respect to data rate monotonicity, as v increases, the entropy of the amplitude symbols (H(Aₘ)) decreases because the distribution moves further away from a uniform distribution (which maximizes entropy). Since the data rate is approximated by this entropy plus the fraction factor (R≈H(Aₘ)+γ), the data rate R(v, γ) is also a non-increasing function of v.

These properties can dictate that for any fixed fraction factor γ (represented by a horizontal line across the graph), the maximum achievable data rate that still satisfies reliability requirements is found at the intersection with the BLER (v, γ)=ϵ curve. To the left of this curve, the data rate is higher, but the BLER exceeds the allowed threshold ϵ (making the transmission unreliable). To the right of this curve, the BLER is safely below ϵ, but the data rate may be suboptimal because the shaping is more aggressive than necessary.

Therefore, FIG. 6 visually demonstrates the logic behind the efficient one-dimensional search method proposed in the disclosure. Instead of performing an exhaustive grid search over the entire hatched region 608, the system fixes a candidate γ and performs a bisection search along the horizontal axis to find the precise shaping parameter v where BLER(v, γ)=ϵ. This converts a computationally expensive 2D area search into a rapid series of 1D line searches, enabling the generation of optimal look-up tables (LUTs) for real-time link adaptation.

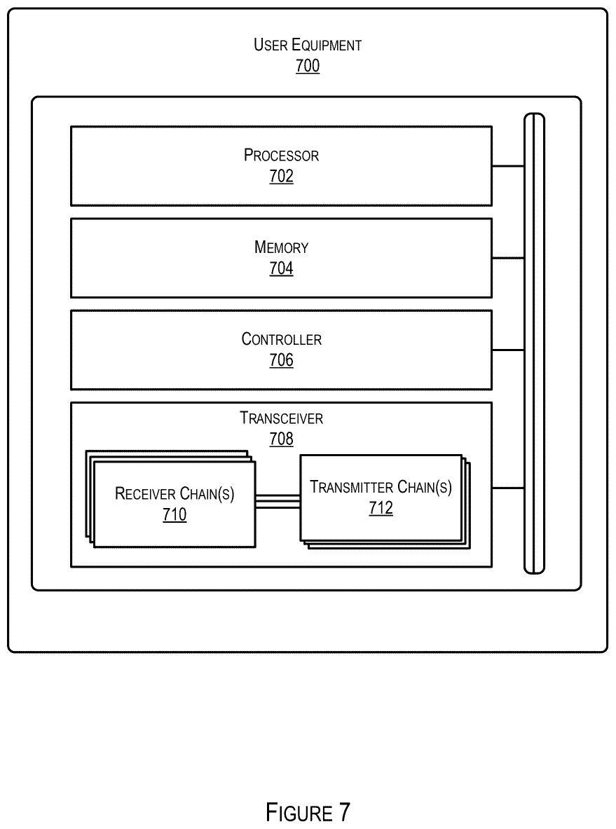

FIG. 7 illustrates an example of a UE 700 in accordance with aspects of the present disclosure. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a digital signal processor (DSP), a central processing unit (CPU), an application specific integrated circuit (ASIC), a field programmable gate array (FPGA), or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions when executed by the processor 702 cause the UE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform one or more of the functions described herein (e.g., executing, by the processor 702, instructions stored in the memory 704). For example, the processor 702 may support wireless communication at the UE 700 in accordance with examples as disclosed herein. The UE 700 may be configured to support a means for obtaining information associated with a number of symbols (n) that are associated with received data. The UE 700 can access a data structure comprising a plurality of channel condition parameters associated with a plurality of system tuples. Each system tuple of the plurality of system tuples can comprise a discrete modulation order (m), a shaping parameter (v), and a fraction factor (γ) that corresponds to a different value of the channel condition parameter of the plurality of channel condition parameters. Further, the UE 700 can identify, via the data structure, based at least in part on the information associated with the received system tuple, an identified system tuple of the plurality of system tuples, that corresponds to the received data. Furthermore, the UE 700 can decode, based at least in part on the identified system tuple and/or the obtained number of symbols (n), the received data.

The controller 706 may manage input and output signals for the UE 700. The controller 706 may also manage peripherals not integrated into the UE 700. In some implementations, the controller 706 may utilize an operating system such as iOS®, ANDROID®, WINDOWS®, or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receiving the signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding and/or processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to a power level suitable for transmission over the wireless medium. The transmitter chain 712 may also include one or more antennas for transmitting the amplified signal into the air or wireless medium.

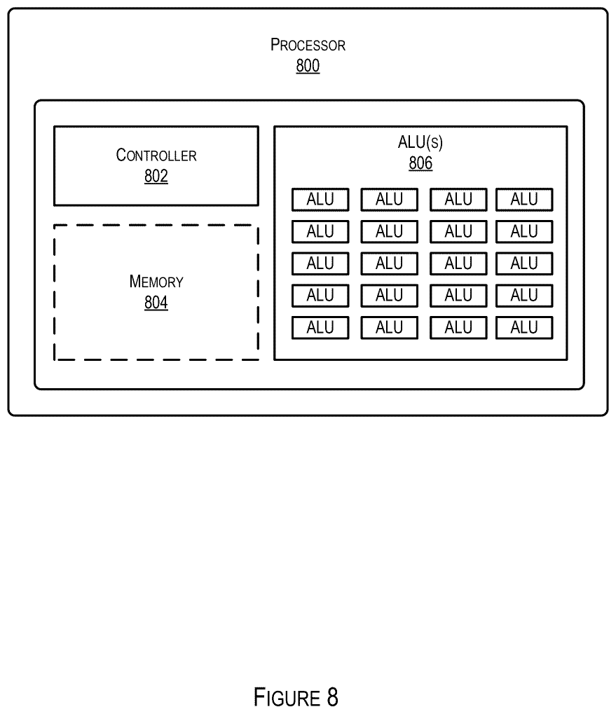

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1/L2/L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory address of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, arithmetic logic units (ALUs), and other functional units of the processor 800.

The memory 804 may include one or more caches (e.g., memory local to or included in the processor 800 or other memory, such as RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside externally to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, the controller 802, and the memory 804 may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside externally to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 may be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

The processor 800 may support wireless communication in accordance with examples as disclosed herein. The processor 800 may be configured to, or operable to support, a means for obtaining a value of a channel condition parameter and a number of symbols (n). The processor 800 can access a data structure comprising a plurality of channel condition parameters associated with a plurality of system tuples. Each system tuple of the plurality of system tuples can comprise a discrete modulation order (m), a shaping parameter (v), and a fraction factor (γ). Each system tuple can correspond to a different value of the channel condition parameter of the plurality of channel condition parameters. The processor 800 can identify the system tuple of the plurality of system tuples that correspond to the obtained value of the channel condition parameter. The processor 800 can transmit, to a user equipment (UE), first information associated with the system tuple that corresponds to the obtained value of the channel condition parameter and/or second information associated with the obtained number of symbols.

In some instances, the processor 800 may be configured to, capable of, or operable to obtain a channel condition parameter and a number of symbols (n). The processor can select a discrete modulation order (m) from a plurality of candidate values. The processor can determine, using a data rate optimization function based at least in part on the channel condition parameter, a system tuple comprising the discrete modulation order (m), a shaping parameter (v), and a fraction factor (γ) for a PAS scheme by reducing a solution space for the shaping parameter (v) and the fraction factor (γ) based at least in part on a channel capacity threshold. Furthermore, the processor can generate a data structure that associates the system tuple with the channel condition parameter.

In some instances, the processor 800 can be configured to, or operable to support, a means for obtaining information associated with a number of symbols (n) that are associated with received data. The processor 800 can access a data structure comprising a plurality of channel condition parameters associated with a plurality of system tuples. Each system tuple of the plurality of system tuples can comprise a discrete modulation order (m), a shaping parameter (v), and a fraction factor (γ) that corresponds to a different value of the channel condition parameter of the plurality of channel condition parameters. Further, the processor 800 can identify, via the data structure, based at least in part on the information associated with the received system tuple, an identified system tuple of the plurality of system tuples, that corresponds to the received data. Furthermore, the processor 800 can decode, based at least in part on the identified system tuple and/or the obtained number of symbols (n), the received data.

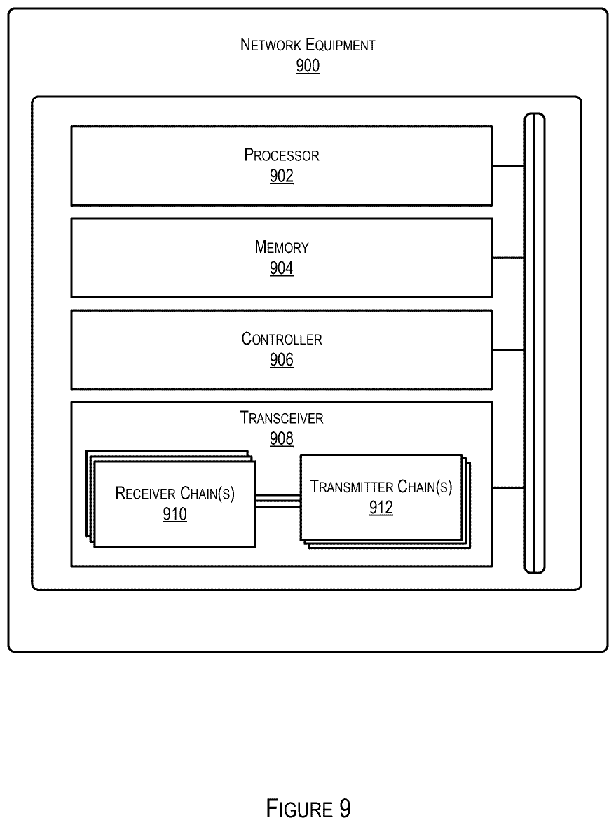

FIG. 9 illustrates an example of a NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform one or more of the functions described herein (e.g., executing, by the processor 902, instructions stored in the memory 904). For example, the processor 902 may support wireless communication at the NE 900 in accordance with examples as disclosed herein. The NE 900 may be configured to support a means for obtaining a value of a channel condition parameter and a number of symbols (n). The NE 900 can access a data structure comprising a plurality of channel condition parameters associated with a plurality of system tuples. Each system tuple of the plurality of system tuples can comprise a discrete modulation order (m), a shaping parameter (v), and a fraction factor (γ). Each system tuple can correspond to a different value of the channel condition parameter of the plurality of channel condition parameters. The NE 900 can identify the system tuple of the plurality of system tuples that correspond to the obtained value of the channel condition parameter. The NE 900 can transmit, to a user equipment (e.g., UE 700), first information associated with the system tuple that corresponds to the obtained value of the channel condition parameter and/or second information associated with the obtained number of symbols.

In some instances, the NE 900 may be configured to, capable of, or operable to obtain a channel condition parameter and a number of symbols (n). The NE 900 can select a discrete modulation order (m) from a plurality of candidate values. The NE 900 can determine, using a data rate optimization function based at least in part on the channel condition parameter, a system tuple comprising the discrete modulation order (m), a shaping parameter (v), and a fraction factor (γ) for a PAS scheme by reducing a solution space for the shaping parameter (v) and the fraction factor (γ) based at least in part on a channel capacity threshold. Furthermore, the NE 900 can generate a data structure that associates the system tuple with the channel condition parameter.

The controller 906 may manage input and output signals for the NE 900. The controller 906 may also manage peripherals not integrated into the NE 900. In some implementations, the controller 906 may utilize an operating system such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas for receiving the signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding and/or processing the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to a power level suitable for transmission over the wireless medium. The transmitter chain 912 may also include one or more antennas for transmitting the amplified signal into the air or wireless medium.

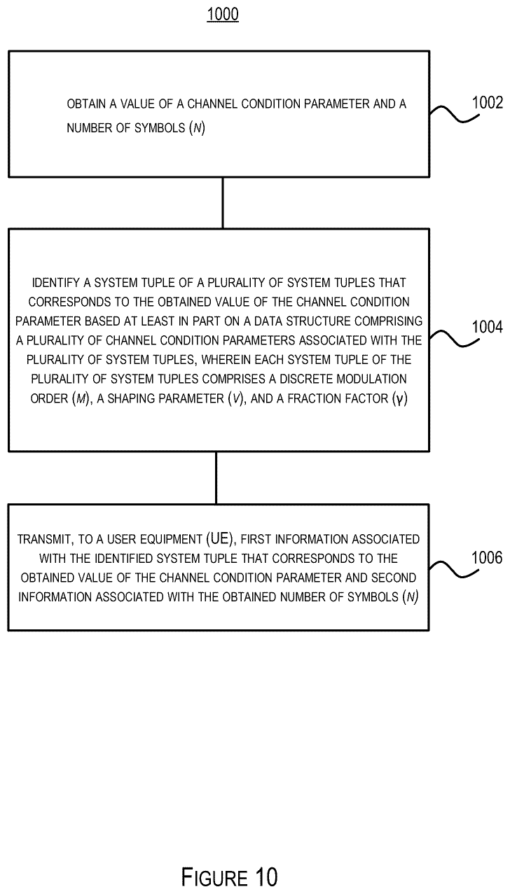

FIG. 10 illustrates a flowchart of a method in accordance with aspects of the present disclosure. The operations of the method 1000 may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1002, the method may include obtaining a value of a channel condition parameter and a number of symbols (n). The operations of 1002 may be performed in accordance with examples as described herein. In some implementations, aspects of the operations of 1002 may be performed by a NE as described with reference to FIG. 9.

At 1004, the method may include identifying the system tuple of the plurality of system tuples that corresponds to the value of the obtained channel condition parameter, based at least in part on a data structure. The data structure can comprise a plurality of channel condition parameters associated with a plurality of system tuples. The operations of 1004 may be performed in accordance with examples as described herein. In some implementations, aspects of the operations of 1004 may be performed by a NE as described with reference to FIG. 9.

At 1006, the method may include transmitting, to a user equipment (UE), first information associated with the identified system tuple that corresponds to the obtained value of the channel condition parameter and/or second information associated with the obtained number of symbols. The operations of 1006 may be performed in accordance with examples as described herein. In some implementations, aspects of the operations of 1006 may be performed by a NE as described with reference to FIG. 9.

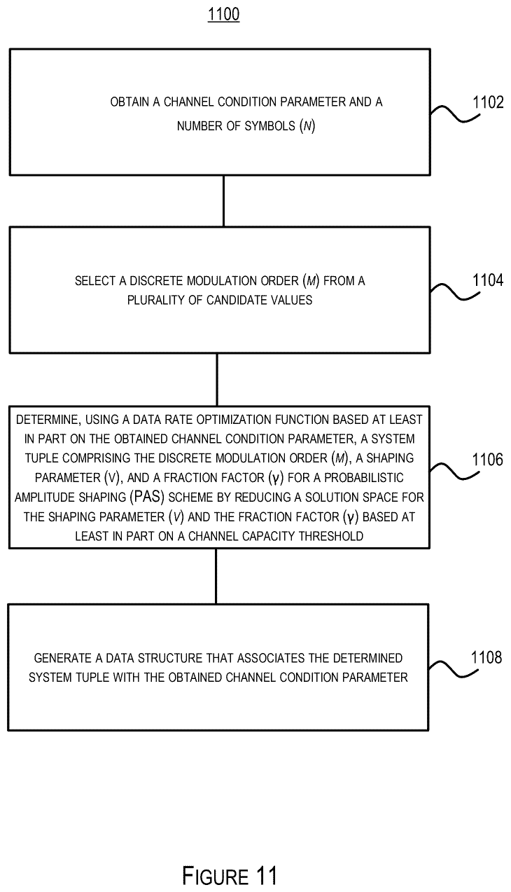

FIG. 11 illustrates a flowchart of a method in accordance with aspects of the present disclosure. The operations of the method 1100 may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1102, the method may include obtaining a channel condition parameter and/or a number of symbols (n). The operations of 1102 may be performed in accordance with examples as described herein. In some implementations, aspects of the operations of 1102 may be performed by a NE as described with reference to FIG. 9.

At 1104, the method may include selecting a discrete modulation order (m) from a plurality of candidate values. The operations of 1104 may be performed in accordance with examples as described herein. In some implementations, aspects of the operations of 1104 may be performed by a NE as described with reference to FIG. 9.

At 1106, the method may include determining a system tuple. Determining the system tuple can be based at least in part on using a data rate optimization function based at least in part on the channel condition parameter. The system tuple can comprise the discrete modulation order (m), a shaping parameter (v), and a fraction factor (γ) for a PAS scheme. Further, the system tuple can be determined by reducing a solution space for the shaping parameter (v) and the fraction factor (γ) based at least in part on a channel capacity threshold. The operations of 1106 may be performed in accordance with examples as described herein. In some implementations, aspects of the operations of 1106 may be performed by a NE as described with reference to FIG. 9.

At 1108, the method may include generating a data structure that associates the system tuple with the channel condition parameter. The operations of 1108 may be performed in accordance with examples as described herein. In some implementations, aspects of the operations of 1108 may be performed by a NE as described with reference to FIG. 9.

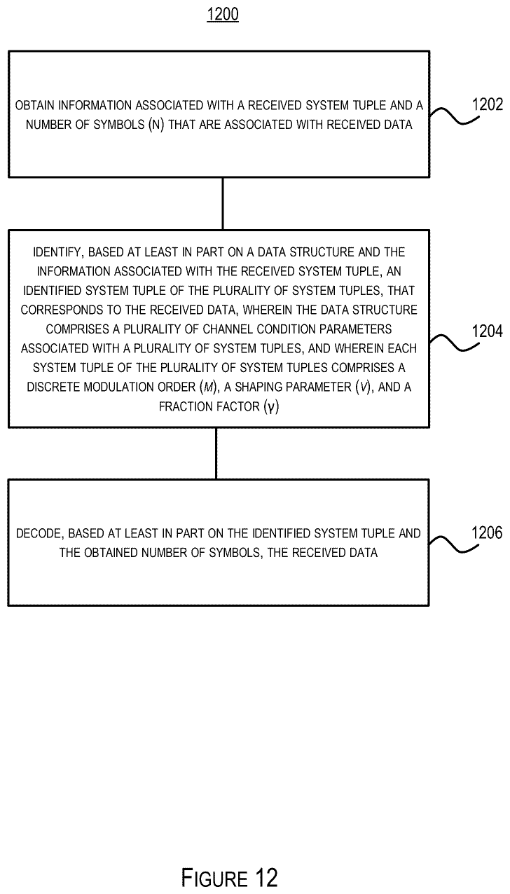

FIG. 12 illustrates a flowchart of a method in accordance with aspects of the present disclosure. The operations of the method 1200 may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1202, the method may include obtaining information associated with a number of symbols (n) that can be associated with received data. The operations of 1202 may be performed in accordance with examples as described herein. In some implementations, aspects of the operations of 1202 may be performed by a UE as described with reference to FIG. 7.

At 1204, the method may include identifying an identified system tuple that corresponds to the received data. Identifying the system tuple may be based at least in part on a data structure and/or information associated with the received system tuple. The data structure can comprise a plurality of channel condition parameters associated with a plurality of system tuples. Each system tuple of the plurality of system tuples can comprise a discrete modulation order (m), a shaping parameter (v), and a fraction factor (γ). The operations of 1204 may be performed in accordance with examples as described herein. In some implementations, aspects of the operations of 1204 may be performed by a UE as described with reference to FIG. 7.

At 1206, the method may include decoding the received data. Decoding the received data may be based at least in part on the identified system tuple and/or the obtained number of symbols (n). The operations of 1206 may be performed in accordance with examples as described herein. In some implementations, aspects of the operations of 1206 may be performed by a UE as described with reference to FIG. 7.

The following provides an overview of aspects of the present disclosure:

Example 1 relates to a method for wireless communication. The method can be performed by a NE. The method can include obtaining a value of a channel condition parameter and a number of symbols (n). The method may include identifying a system tuple of a plurality of system tuples that corresponds to the obtained value of the channel condition parameter based at least in part on a data structure. The data structure can comprise a plurality of channel condition parameters associated with the plurality of system tuples. Each system tuple of the plurality of system tuples can comprise a discrete modulation order (m), a shaping parameter (v), and/or a fraction factor (γ). The method may include transmitting, to a user equipment (UE), first information associated with the system tuple that corresponds to the obtained value of the channel condition parameter and/or second information associated with the obtained number of symbols.

Example 2 includes the method of example 1. In this example, the channel condition parameter can comprise a signal to noise ratio (SNR), a signal to interference plus noise ratio (SINR), or a channel quality indicator (CQI).

Example 3 includes the method of any of the examples 1 or 2. In this example, determining the shaping parameter (v) for each system tuple of the plurality of system tuples can comprise performing a bisection search that identifies a value in which a block error rate (BLER) associated with the channel condition parameter matches a BLER constraint that is based at least in part on the fraction factor (γ).

Example 4 includes the method of any of the examples 1 to 3. In this example, the system tuple can be identified based at least in part on performance of a one-dimensional search over the fraction factor (γ) to identify a pair of (v, γ) that maximizes a data rate. The shaping parameter (v) can be dependent on the fraction factor (γ).

Example 5 includes the method of any of the examples 1 to 4. In this example, based at least in part on a type of the channel condition parameter, the data structure can map a continuous range of channel condition parameter values to a discrete index associated with the system tuple.

Example 6 includes the method of any of the examples 1 to 5. In this example, the NE can further comprise a distribution matcher (DM) that is configured to cause the determination (e.g., determination by a base station) of amplitude symbols following a probability distribution based at least in part on the shaping parameter (v).

Example 7 includes the method of any of the examples 1 to 6. In this example, the method includes determining a data rate associated with the system tuple. The data rate can be approximated with an entropy of amplitude symbols and the fraction factor (γ).

Example 8 includes the method of any of the examples 1 to 7. In this example, the data structure can comprise a look-up table, a sorted array, or a coefficient array.

Example 9 includes the method of any of the examples 1 to 8. In this example, the method includes transmitting information associated with an updated system tuple that is based at least in part on real-time variations in the obtained channel condition parameter.

Example 10 includes the method of any of the examples 1 to 9. In this example, the method includes, based at least in part on the channel condition parameter being continuous, quantize the channel condition parameter to a nearest discrete value or index defined in the data structure.

Example 11 includes the method of any of the examples 1 to 10. In this example, the method includes, determining, based at least in part on the fraction factor (γ), a number of non-shaped information bits allocated to a Forward Error Correction (FEC) encoder relative to a total number of transmit symbols.

Example 12 relates to a method for wireless communication. The method can be performed by a NE. The method can include obtaining a channel condition parameter and a number of symbols (n). The method can include selecting a discrete modulation order (m) from a plurality of candidate values. The method can include determining, using a data rate optimization function based at least in part on the channel condition parameter, a system tuple comprising the discrete modulation order (m), a shaping parameter (v), and a fraction factor (γ) for a PAS scheme by reducing a solution space for the shaping parameter (v) and the fraction factor (γ) based at least in part on a channel capacity threshold. Furthermore, the method can include generating a data structure that associates the system tuple with the channel condition parameter.

Example 13 includes the method of example 12. In this example, the method can include identifying an achievable data rate that is associated with the channel condition parameter and corresponds to a block error rate (BLER) constraint.

Example 14 includes the method of example 12 or 13. In this example, the method can include reducing, based at least in part on application of a channel capacity constraint to a parameter pair, the solution space for the parameter pair, wherein the parameter pair comprises the shaping parameter and the fraction factor.

Example 15 includes the method of any of examples 12 to 14. In this example, the method can include determining, for each candidate fraction factor of a plurality of candidate fraction factors, based at least in part on application of a bisection search to a range of values for the shaping parameter, the shaping parameter that matches the BLER constraint.

Example 16 includes the method of any of examples 12 to 15. In this example, the method can include identifying the parameter pair for the discrete modulation order that results in the achievable data rate by performing a search over the plurality of candidate fraction factors.

Example 17 the method of any of examples 12 to 16. In this example, the method can include determining, based at least in part on the selected discrete modulation order, the reduced solution space, the shaping parameter that matches the BLER constraint, the identified parameter pair, the system tuple comprising the discrete modulation order, the shaping parameter, and the fraction factor that results in the achievable data rate.

Example 18 relates to a method for wireless communication. The method can be performed by a UE. The method can include obtaining information associated with a number of symbols (n) that are associated with received data. Further, the method can include identifying, based at least in part on the data structure and the information associated with the received system tuple and/or the obtained number of symbols (n) that are associated with received data, an identified system tuple of the plurality of system tuples, that corresponds to the received data. The data structure can comprise a plurality of channel condition parameters associated with a plurality of system tuples. Each system tuple of the plurality of system tuples can comprise a discrete modulation order (m), a shaping parameter (v), and a fraction factor (γ) that corresponds to a different value of the channel condition parameter of the plurality of channel condition parameters. Furthermore, the method can include decoding, based at least in part on the identified system tuple and/or the obtained number of symbols (n), the received data.

Example 19 includes the method of example 18. In this example, information associated with the data structure is transmitted to the UE from a base station.

Example 20 includes the method of any of examples 18 or 19. In this example, the identified system tuple is used to decode the received data a predefined time period after the received data was received.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The description provided herein, along with the accompanying figures, illustrates certain example implementations and is not intended to encompass all possible implementations within the scope of the claims. As used herein, the term “example” is intended to convey an illustration or instance, and does not imply a preferred or superior implementation. The detailed description includes specific features and elements to facilitate understanding of the implementations described in the present disclosure. However, these implementations may also be realized without some or all of the specified details.

What is claimed is:

1. A base station for wireless communication, comprising:
one or more memories; and
one or more processors coupled with the one or more memories and individually or collectively operable to cause the base station to:
obtain a value of a channel condition parameter and a number of symbols (n);
identify a system tuple of a plurality of system tuples that corresponds to the obtained value of the channel condition parameter based at least in part on a data structure, wherein the data structure comprises a plurality of channel condition parameters associated with the plurality of system tuples, wherein each system tuple of the plurality of system tuples comprises a discrete modulation order (m), a shaping parameter (v), and a fraction factor (γ); and
transmit, to a user equipment (UE), first information associated with the identified system tuple that corresponds to the obtained value of the channel condition parameter and second information associated with the obtained number of symbols.

2. The base station of claim 1, wherein the channel condition parameter comprises a signal to noise ratio (SNR), a signal to interference plus noise ratio (SINR), or a channel quality indicator (CQI).

3. The base station of claim 1, wherein the determining the shaping parameter (v) for each system tuple of the plurality of system tuples can comprise a bisection search that identifies a value in which a block error rate (BLER) associated with the channel condition parameter matches a BLER constraint that is based at least in part on the fraction factor (γ).

4. The base station of claim 1, wherein each system tuple corresponds to a different value of the channel condition parameter of the plurality of channel condition parameters, wherein the system tuple is identified based at least in part on performance of a one-dimensional search over the fraction factor (γ) to identify a pair of (v, γ) that maximizes a data rate, and wherein the shaping parameter (v) is dependent on the fraction factor (γ).

5. The base station of claim 1, wherein, based at least in part on a type of the channel condition parameter, the data structure maps a continuous range of channel condition parameter values to a discrete index associated with the identified system tuple.

6. The base station of claim 1, wherein the base station further comprises:
a distribution matcher (DM) that is configured to cause the base station to determine amplitude symbols following a probability distribution based at least in part on the shaping parameter (v).

7. The base station of claim 1, wherein the one or more processors cause the base station to:
determine a data rate associated with the system tuple, wherein the data rate is approximated with an entropy of amplitude symbols and the fraction factor (γ).

8. The base station of claim 1, wherein the data structure comprises a look-up table, a sorted array, or a coefficient array.

9. The base station of claim 1, wherein the one or more processors cause the base station to:
transmit information associated with an updated system tuple that is based at least in part on real-time variations in the channel condition parameter.

10. The base station of claim 1, wherein the one or more processors cause the base station to:
based at least in part on the channel condition parameter being continuous, quantize the channel condition parameter to a nearest discrete value or index defined in the data structure.

11. The base station of claim 1, wherein the one or more processors cause the base station to:
determine, based at least in part on the fraction factor (γ), a number of non-shaped information bits allocated to a Forward Error Correction (FEC) encoder relative to a total number of transmit symbols.

12. A method performed or performable by a base station, the method comprising:
obtaining a channel condition parameter and a number of symbols (n);
selecting a discrete modulation order (m) from a plurality of candidate values;
determining, using a data rate optimization function based at least in part on the channel condition parameter, a system tuple comprising the discrete modulation order (m), a shaping parameter (v), and a fraction factor (γ) for a probabilistic amplitude shaping (PAS) scheme by reducing a solution space for the shaping parameter (v) and the fraction factor (γ) based at least in part on a channel capacity threshold; and
generating a data structure that associates the determined system tuple with the obtained channel condition parameter.

13. The method of claim 12, further comprising:
identifying an achievable data rate that is associated with the channel condition parameter and corresponds to a block error rate (BLER) constraint.

14. The method of claim 13, further comprising:
reducing, based at least in part on application of a channel capacity constraint to a parameter pair, the solution space for the parameter pair, wherein the parameter pair comprises the shaping parameter and the fraction factor.

15. The method of claim 14, further comprising:
determining, for each candidate fraction factor of a plurality of candidate fraction factors, based at least in part on application of a bisection search to a range of values for the shaping parameter, the shaping parameter that matches the BLER constraint.

16. The method of claim 15, further comprising:
identifying the parameter pair for the discrete modulation order that results in the achievable data rate by performing a search over the plurality of candidate fraction factors.

17. The method of claim 16, further comprising:
determining, based at least in part on the selected discrete modulation order, the reduced solution space, the shaping parameter that matches the BLER constraint, the identified parameter pair, the system tuple comprising the discrete modulation order, the shaping parameter, and the fraction factor that results in the achievable data rate.

18. A user equipment (UE) for wireless communication, comprising:
one or more memories; and
one or more processors coupled with the one or more memories and individually or collectively operable to cause the UE to:
obtain information associated with a received system tuple and a number of symbols (n) that are associated with received data;
identify, based at least in part on a data structure and the information associated with the received system tuple, an identified system tuple of a plurality of system tuples, that corresponds to the received data, wherein the data structure comprises a plurality of channel condition parameters associated with a plurality of system tuples, and wherein each system tuple of the plurality of system tuples comprises a discrete modulation order (m), a shaping parameter (v), and a fraction factor (γ); and
decode, based at least in part on the identified system tuple and the obtained number of symbols (n), the received data.

19. The UE of claim 18, wherein information associated with the data structure is transmitted to the UE from a base station.

20. The UE of claim 18, wherein the identified system tuple is used to decode the received data a predefined time period after the received data was received.
